(19) United States
(12) Patent Application Publication
(10) Pub. No.: US 2019/0154198 A1
(43) Pub. Date: May 23, 2019

(54) Hose Lubricating Assembly

(71) Applicant: Vincent Moore, Coatesville, PA (US)

(72) Inventor: Vincent Moore, Coatesville, PA (US)

(21) Appl. No.: 15/820,612

(22) Filed: Nov. 22, 2017

(51) Int. Cl. F16N 3/08

(52) U.S. Cl. CPC F16N 3/08; F16N 19/00

(57) ABSTRACT

A hose lubricating assembly includes a handle that has an interior space therein. A reservoir is positioned in the interior space and the reservoir contains a fluid lubricant. A tube is coupled to the handle such that the tube is in fluid communication with the reservoir and the tube receives the fluid lubricant. The tube is selectively inserted between a hose and a stem that the hose is coupled to. Thus, the fluid lubricant is released between the hose and the stem for removing the hose from the stem. A plunger unit is movably coupled to the handle and the plunger unit selectively urges the fluid lubricant outwardly through the tube. A valve is movably positioned within the handle and the valve is in fluid communication with the reservoir. The valve is selectively opened and closed for inhibiting and facilitating the fluid lubricant to be released from the reservoir.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to lubricating devices and more particularly pertains to a new lubricating device for PURPOSE.

### BRIEF SUMMARY OF THE INVENTION

An embodiment of the disclosure meets the needs presented above by generally comprising a handle that has an interior space therein. A reservoir is positioned in the interior space and the reservoir contains a fluid lubricant. A tube is coupled to the handle such that the tube is in fluid communication with the reservoir and the tube receives the fluid lubricant. The tube is selectively inserted between a hose and a stem that the hose is coupled to. Thus, the fluid lubricant is released between the hose and the stem for removing the hose from the stem. A plunger unit is movably coupled to the handle and the plunger unit selectively urges the fluid lubricant outwardly through the tube. A valve is movably positioned within the handle and the valve is in fluid communication with the reservoir. The valve is selectively opened and closed for inhibiting and facilitating the fluid lubricant to be released from the reservoir.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hose lubricating assembly according to an embodiment of the disclosure.

FIG. 2 is a right view of an embodiment of the disclosure.

FIG. 3 is a back end view of an embodiment of the disclosure.

FIG. 4 is a cross sectional view taken along line 4-4 of FIG. 3 of an embodiment of the disclosure.

FIG. 5 is a front view of an embodiment of the disclosure.

FIG. 6 is a perspective in-use view of an embodiment of the disclosure.

### DETAILED DESCRIPTION OF THE INVENTION

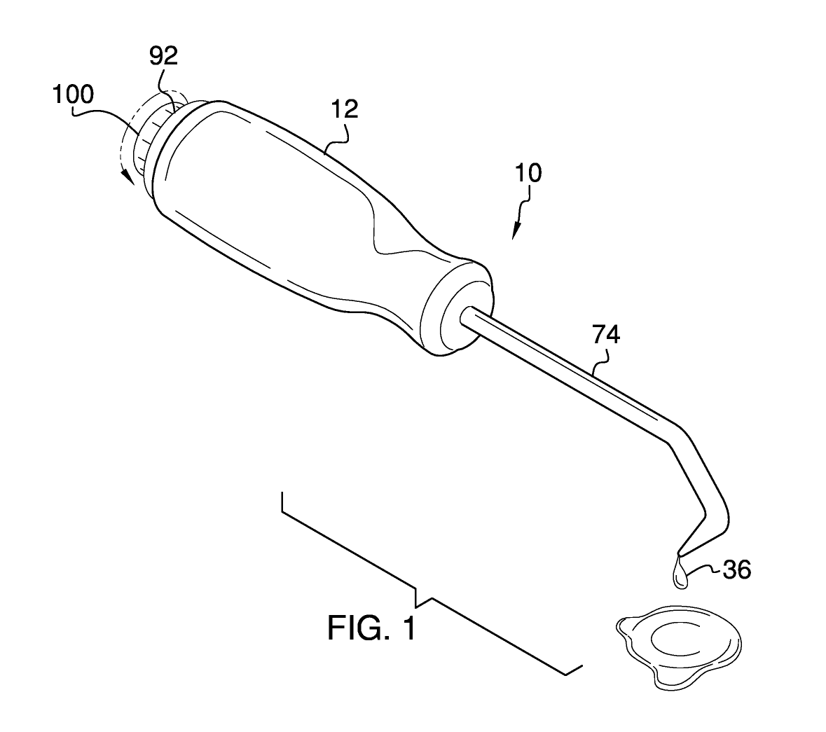

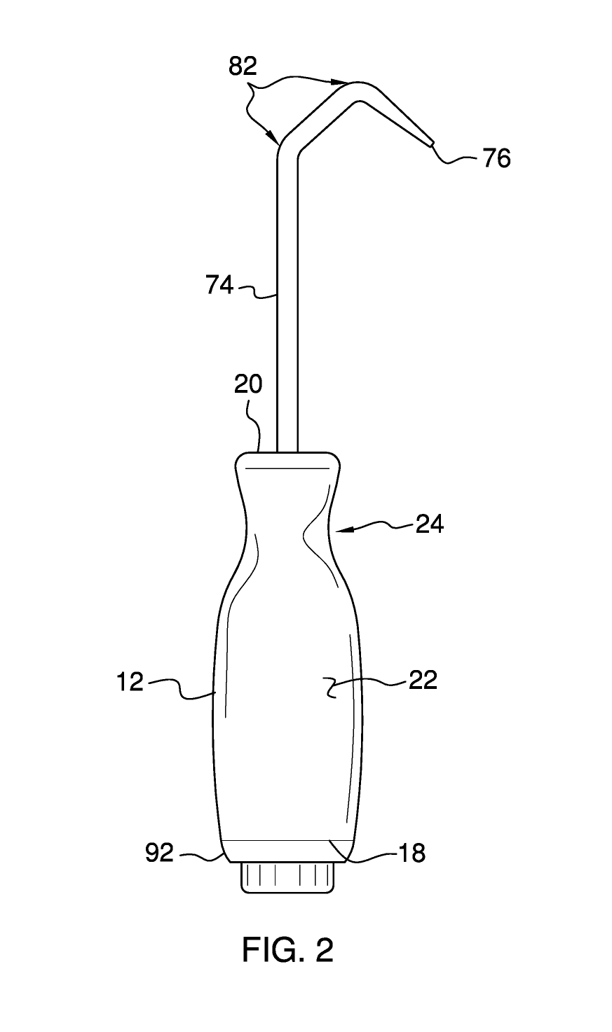

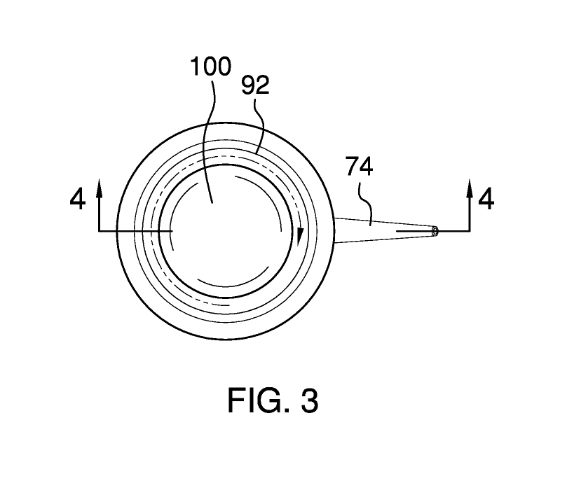

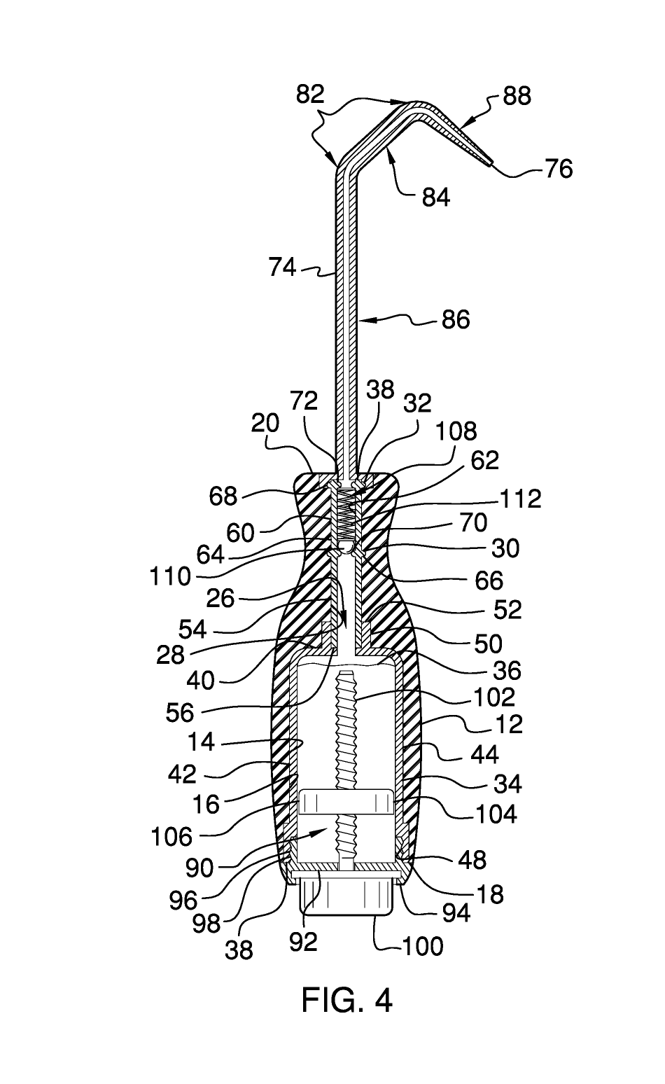

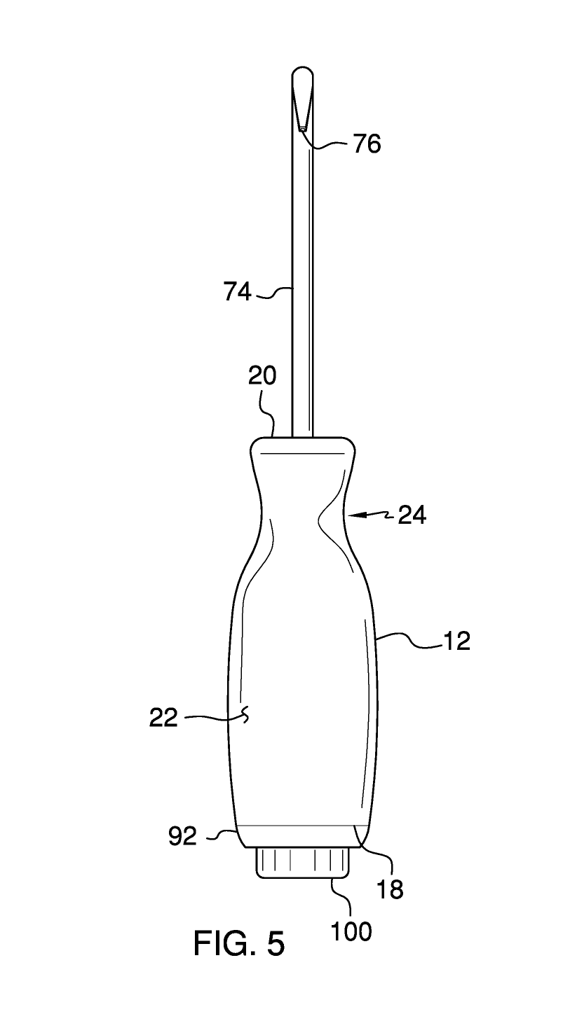

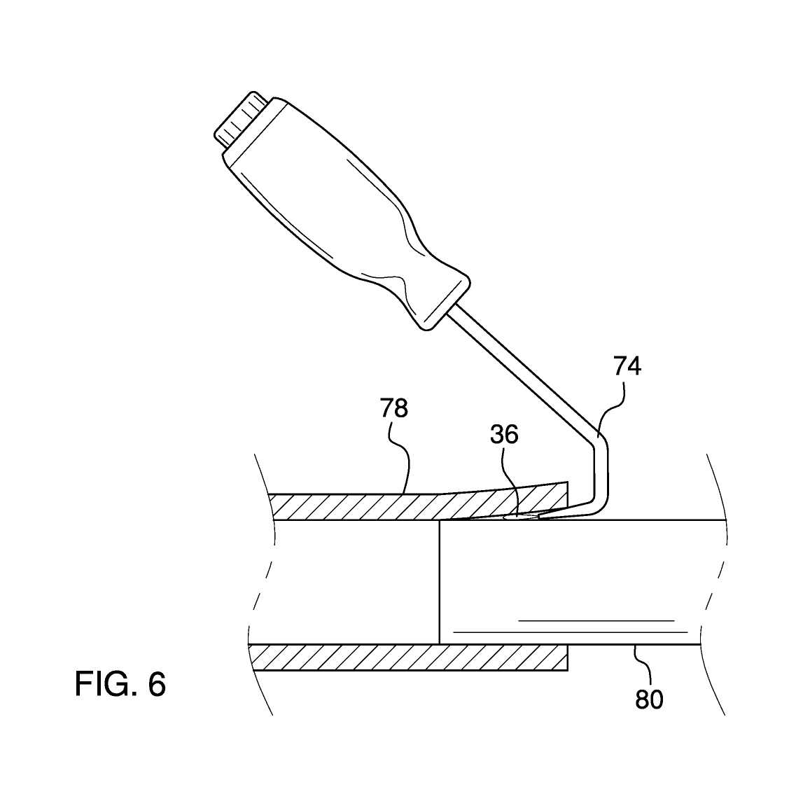

With reference now to the drawings, and in particular to FIGS. 1 through 6 thereof, a new lubricating device embodying the principles and concepts of an embodiment of the disclosure and generally designated by the reference numeral 10 will be described.

As best illustrated in FIGS. 1 through 6, the hose lubricating assembly 10 generally comprises a handle 12 that may be gripped. The handle 12 has an interior space 14 therein and the interior space 14 has a bounding surface 16. The handle 12 has a first end 18, a second end 20 and an outer surface 22 extending therebetween. The outer surface 22 is continuous such that the handle 12 has a cylindrical shape. Moreover, the outer surface 22 has a depression 24 extending inwardly therein for receiving fingers thereby enhancing gripping the handle 12.

The first end 18 is open into the interior space 14 and the second end 20 has a channel 26 extending toward the first end 18 and intersecting the interior space 14. Moreover, the channel 26 is in fluid communication with the interior space 14. The channel 26 has an outer bounding surface 28 and the outer bounding surface 28 has a first detent 30 extending outwardly toward the outer surface 22 of the handle 12. The first detent 30 is positioned between the interior space 14 and the second end 20. The outer bounding surface 28 has a second detent 32 extending outwardly toward the outer surface 22 of the handle 12 and the second detent 32 is positioned between the second end 20 and the first detent 30.

A reservoir 34 is positioned in the interior space 14 and the reservoir 34 contains a fluid lubricant 36. The fluid lubricant 36 may be a petroleum product such as oil or other friction reducing lubricant. The reservoir 34 has a first end 38, a second end 40 and an outer wall 42 extending therebetween and the outer wall 42 has an outside surface 44 and an inside surface 46. The outside surface 44 of the reservoir 34 engages the bounding surface of the interior space 14 and the first end 38 of the reservoir 34 is aligned with the first end 18 of the handle 12. The inside surface 46 has a threaded portion 48 and the threaded portion 48 extends from the first end 18 of the reservoir 34 toward the second end 20 of the reservoir 34.

A first sleeve 50 is coupled to and extends away from the second end 20 of the reservoir 34. The first sleeve 50 is aligned with the channel 26 in the handle 12 and the first sleeve 50 has a distal end 52 with respect to the reservoir 34. A second sleeve 54 is provided that has a primary end 56, a secondary end 58 and an outer wall 60 extending therebetween. The outer wall 60 of the second sleeve 54 has an interior surface 62 and an exterior surface 64. The exterior surface 64 has a first ridge 66 extending outwardly therefrom and the first ridge 66 is positioned between the primary end 56 and the secondary end 58. The exterior surface 64 has a second ridge 68 extending outwardly therefrom and the second ridge 68 is aligned with the secondary end 58 of the second sleeve 54.

The interior surface 62 has a third ridge 70 extending inwardly toward a center of the second sleeve 54 and the third ridge 70 is aligned with the first ridge 66. The interior surface 62 has a fourth ridge 72 extending inwardly toward the center of the second sleeve 54 and the fourth ridge 72 is aligned with the second ridge 68. The second sleeve 54 is positioned within the channel 26 and the distal end 52 of the first sleeve 50 insertably receives the primary end 56 of the second sleeve 54. The first ridge 66 engages the first detent 30 and the second ridge 68 engages the second detent 32 such that the second sleeve 54 is retained within the channel 26.

A tube 74 is coupled to the handle 12 such that the tube 74 is in fluid communication with the reservoir 34 to receive the fluid lubricant 36. The tube 74 has a distal end 76 with respect to the handle 12 and the distal end 76 of the tube 74 is selectively inserted between a hose 78 and a stem 80 that the hose 78 is coupled to. The hose 78 may be a radiator hose, a fuel fill hose and any other hose commonly found on an automobile or other machine. The stem 80 may be a radiator inlet, a fuel inlet and any other stem 80 commonly found on an automobile or other machine. The tube 74 is inserted between the hose 78 and stem 80 to facilitate the fluid lubricant 36 to be released between the hose 78 and the stem 80. In this way the fluid lubricant 36 eases removing the hose 78 from the stem 80.

The tube 74 has a pair of bends 82 thereon and the bends 82 are spaced apart from each other and are distributed from the distal end 76 of the tube 74 toward the handle 12. The bends 82 define a central portion 84 of the tube 74 forming an angle with a first portion 86 of the tube 74 and a second portion 88 of the tube 74. The first portion 86 of the tube 74 engages the outer bounding surface 28 of the channel 26 having the tube 74 extending away from the second end 20 of the handle 12. The second portion 88 of the tube 74 is selectively inserted between the hose 78 and the stem 80. The tube 74 is comprised of a rigid material such as steel or the like.

A plunger unit 90 is movably coupled to the handle 12 and the plunger unit 90 is selectively manipulated. The plunger unit 90 is in fluid communication with the reservoir 34 to selectively urge the fluid lubricant 36 outwardly through the tube 74. The plunger unit 90 comprises a cap 92 that has a first wall 94 and a perimeter wall 96 extending away from the first wall 94. The perimeter wall 96 is continuous such that the perimeter wall 96 forms a closed loop. The perimeter wall 96 has an outside surface 98 and he outside surface 98 of the perimeter wall 96 threadably engages the threaded portion 48 on the outer wall 42 of the reservoir 34. In this way the cap 92 is releasbly retained on the handle 12.

A knob 100 is rotatably coupled to the first wall 94 of the cap 92 and the knob 100 is selectively manipulated. The knob 100 is selectively rotated in a first direction and the knob 100 is selectively rotated in a second direction. A screw 102 is coupled to and extends away from the knob 100. The screw 102 extends through the first wall 94 of the cap 92 such that the screw 102 extends into the reservoir 34.

A disk 104 is provided that has a peripheral edge 106 and the screw 102 extends through the disk 104 such that the disk 104 threadably engages the screw 102. The peripheral edge 106 of the disk 104 engages the inside surface 46 of the reservoir 34. Moreover, the peripheral edge 106 forms a fluid impermeable seal with the inside surface 46 of the reservoir 34. The disk 104 is urged along the screw 102 toward the second end 20 of the reservoir 34 when the knob 100 is rotated in the first direction. Thus, the disk 104 urges the fluid lubricant 36 outwardly from the reservoir 34. The disk 104 is urged toward the first end 18 of the reservoir 34 when the knob 100 is rotated in the second direction.

A valve 108 is provided and the valve 108 is movably positioned within the handle 12. Additionally, the valve 108 is in fluid communication with the reservoir 34. The valve 108 is selectively positioned in a closed position to inhibit the fluid lubricant 36 from exiting the reservoir 34. The valve 108 is selectively positioned in an open position to facilitate the fluid lubricant 36 to exit the reservoir 34.

The valve 108 comprises a ball 110 that is slidably positioned in the second sleeve 54 and the ball 110 is positioned between the third ridge 70 and the fourth ridge 72. The ball 110 engages the third ridge 70 and forms a fluid impermeable seal with the third ridge 70 when the valve 108 is in the closed position. In this way the ball 110 inhibits the fluid lubricant 36 from passing beyond the ball 110. The ball 110 is spaced from the third ridge 70 when the valve 108 is in the open position to allow the fluid lubricant 36 to pass beyond the ball 110.

A biasing member 112 is positioned in the second sleeve 54 and the biasing member 112 is positioned between the fourth ridge 72 and the ball 110. The biasing member 112 biases the ball 110 to engage the third ridge 70. The fluid lubricant 36 urges the ball 110 to compress the biasing member 112 toward the fourth ridge 72 when the knob 100 is rotated in the first direction. In this way the fluid lubricant 36 is released outwardly through the distal end of the tube 74.

In use, the cap 92 is removed from the handle 12 and the reservoir 34 is filled with the fluid lubricant 36. The cap 92 is replaced on the handle 12 to close the reservoir 34. The distal end of the tube 74 is selectively inserted between the hose 78 and the stem 80. The knob 100 is rotated in the first direction to urge the fluid lubricant 36 outwardly through the distal end of the tube 74. In this way the fluid lubricant 36 is deposited between the hose 78 and the stem 80 thereby easing removing the hose 78 from the stem 80. The biasing member 112 urges the ball 110 to engage the third ridge 70 when the knob 100 is no longer being rotated in the first direction. In this way the ball 110 inhibits the fluid lubricant 36 from being released outwardly through the distal end of the tube 74.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A hose lubricating assembly being configured to be inserted between a hose and a stem thereby facilitating a lubricant to be distributed between the hose and stem for removing the hose from the stem, said assembly comprising:
a handle being configured to be gripped, said handle having an interior space therein;
a reservoir being positioned in said interior space wherein said reservoir is configured to contain a fluid lubricant;
a tube being coupled to said handle such that said tube is in fluid communication with said reservoir wherein said tube is configured to receive the fluid lubricant, said tube having a distal end with respect to said handle, said distal end being configured to be selectively inserted between a hose and a stem having the hose being coupled thereto thereby facilitating the fluid lubricant to be released between the hose and the stem for removing the hose from the stem;
a plunger unit being movably coupled to said handle wherein said plunger unit is configured to be manipulated, said plunger unit being in fluid communication with said reservoir wherein said plunger unit is configured to selectively urge the fluid lubricant outwardly through said tube; and
a valve being movably positioned within said handle, said valve being in fluid communication with said reservoir, said valve being selectively positioned in a closed position wherein said valve is configured to inhibit the fluid lubricant from exiting said reservoir, said valve being selectively positioned in an open position wherein said valve is configured to facilitate the fluid lubricant to exit said reservoir.

2. The assembly according to claim 1, wherein said interior space has a bounding surface, said handle having a first end, a second end and an outer surface extending therebetween, said outer surface being continuous such that said handle has a cylindrical shape, said first end being open into said interior space.

3. The assembly according to claim 2, wherein said second end has a channel extending toward said first and intersecting said interior space such that said channel is in fluid communication with said interior space.

4. The assembly according to claim 3, wherein said channel has an outer bounding surface, said outer bounding surface having a first detent extending outwardly toward said outer surface of said handle, said first detent being positioned between said interior space and said second end.

5. The assembly according to claim 4, wherein said outer bounding surface having a second detent extending outwardly toward said outer surface of said handle, said second detent being positioned between said second end and said first detent.

6. The assembly according to claim 3, wherein said reservoir has a first end, a second end and an outer wall extending therebetween, said outer wall having an outside surface and an inside surface, said outside surface of said reservoir engaging said bounding surface of said interior space having said first end of said reservoir being aligned with said first end of said handle, said inside surface having a threaded portion, said threaded portion extending from said first end of said reservoir toward said second end of said reservoir.

7. The assembly according to claim 6, further comprising a first sleeve being coupled to and extending away from said second end of said reservoir, said first sleeve being aligned with said channel in said handle, said first sleeve having a distal end with respect to said reservoir.

8. The assembly according to claim 7, further comprising a second sleeve having a primary end, a secondary end and an outer wall extending therebetween, said outer wall of said second sleeve having an interior surface and an exterior surface, said exterior surface having a first ridge extending outwardly therefrom, said first ridge being positioned between said primary end and said secondary end, said exterior surface having a second ridge extending outwardly therefrom, said second ridge being aligned with said secondary end of said second sleeve.

9. The assembly according to claim 8, wherein said interior surface has a third ridge extending inwardly toward a center of said second sleeve, said third ridge being aligned with said first ridge, said interior surface having a fourth ridge extending inwardly toward said center of said second sleeve, said fourth ridge being aligned with said second ridge.

10. The assembly according to claim 9, wherein said second sleeve is positioned within said channel having said distal end of said first sleeve insertably receiving said primary end of said second sleeve, said first ridge engaging said first detent, said second ridge engaging said second detent such that said second sleeve is retained within said channel.

11. The assembly according to claim 4, wherein said tube has a pair of bends thereon, said bends being spaced apart from each other and being distributed from said distal end toward said handle to define a central portion of said tube forming an angle with a first portion of said tube and a second portion of said tube, said first portion of said tube engaging said outer bounding surface of said channel having said tube extending away from said second end of said handle, said second portion of said tube being configured to be selectively inserted between the hose and the stem.

12. The assembly according to claim 11, wherein:
said reservoir has an outer wall, said outer wall having a threaded portion; and
said plunger unit comprises a cap having a first wall and a perimeter wall extending away from said first wall, said perimeter wall being continuous such that said perimeter wall forms a closed loop, said perimeter wall having an outside surface, said outside surface of said perimeter wall threadably engaging said threaded portion on said outer wall of said reservoir to releasbly retain said cap on said handle.

13. The assembly according to claim 12, further comprising a knob being rotatably coupled to said first wall of said cap wherein said knob is configured to be manipulated, said knob being selectively rotated in a first direction, said knob being selectively rotated in a second direction.

14. The assembly according to claim 13, further comprising a screw being coupled to and extending away from said knob, said screw extending through said first wall of said cap such that said screw extends into said reservoir.

15. The assembly according to claim 14, further comprising a disk having a peripheral edge, said screw extending through said disk such that said disk threadably engages said screw, said peripheral edge of said disk engaging an inside surface of said reservoir, said peripheral edge forming a fluid impermeable seal with said inside surface of said reservoir, said disk being urged toward a second end of said reservoir when said knob is rotated in said first direction wherein said disk is configured to urge the fluid lubricant outwardly from said reservoir, said disk being urged toward a first end of said reservoir when said knob is rotated in said second direction.

16. The assembly according to claim 9, wherein said valve comprises a ball being slidably positioned in said second sleeve, said ball being positioned between said third ridge and said fourth ridge, said ball engaging said third ridge and forming a fluid impermeable seal with said third ridge when said valve is in said closed position wherein said ball is configured to inhibit the fluid lubricant from passing beyond said ball, said ball being spaced from said third ridge when said valve is in said open position wherein said ball is configured to allow the fluid lubricant to pass beyond said ball.

17. The assembly according to claim 16, further comprising:
a knob being rotated in a first direction; and
a biasing member being positioned in said second sleeve, said biasing member being positioned between said fourth ridge and said ball, said biasing member biasing said ball to engage said third ridge, said ball compressing said biasing member toward said fourth ridge when said knob is rotated in said first direction.

18. A hose lubricating assembly being configured to be inserted between a hose and a stem thereby facilitating a lubricant to be distributed between the hose and stem for removing the hose from the stem, said assembly comprising:
a handle being configured to be gripped, said handle having an interior space therein, said interior space having a bounding surface, said handle having a first end, a second end and an outer surface extending therebetween, said outer surface being continuous such that said handle has a cylindrical shape, said first end being open into said interior space, said second end having a channel extending toward said first and intersecting said interior space such that said channel is in fluid communication with said interior space, said channel having a outer bounding surface, said outer bounding surface having a first detent extending outwardly toward said outer surface of said handle, said first detent being positioned between said interior space and said second end, said outer bounding surface having a second detent extending outwardly toward said outer surface of said handle, said second detent being positioned between said second end and said first detent;
a reservoir being positioned in said interior space wherein said reservoir is configured to contain a fluid lubricant, said reservoir having a first end, a second end and an outer wall extending therebetween, said outer wall having an outside surface and an inside surface, said outside surface of said reservoir engaging said bounding surface of said interior space having said first end of said reservoir being aligned with said first end of said handle, said inside surface having a threaded portion, said threaded portion extending from said first end of said reservoir toward said second end of said reservoir;
a first sleeve being coupled to and extending away from said second end of said reservoir, said first sleeve being aligned with said channel in said handle, said first sleeve having a distal end with respect to said reservoir;
a second sleeve having a primary end, a secondary end and an outer wall extending therebetween, said outer wall of said second sleeve having an interior surface and an exterior surface, said exterior surface having a first ridge extending outwardly therefrom, said first ridge being positioned between said primary end and said secondary end, said exterior surface having a second ridge extending outwardly therefrom, said second ridge being aligned with said secondary end of said second sleeve, said interior surface having a third ridge extending inwardly toward a center of said second sleeve, said third ridge being aligned with said first ridge, said interior surface having a fourth ridge extending inwardly toward said center of said second sleeve, said fourth ridge being aligned with said second ridge, said second sleeve being positioned within said channel having said distal end of said first sleeve insertably receiving said primary end of said second sleeve, said first ridge engaging said first detent, said second ridge engaging said second detent such that said second sleeve is retained within said channel;
a tube being coupled to said handle such that said tube is in fluid communication with said reservoir wherein said tube is configured to receive the fluid lubricant, said tube having a distal end with respect to said handle, said distal end being configured to be selectively inserted between a hose and a stem having the hose being coupled thereto thereby facilitating the fluid lubricant to be released between the hose and the stem for removing the hose from the stem, said tube having a pair of bends thereon, said bends being spaced apart from each other and being distributed from said distal end toward said handle to define a central portion of said tube forming an angle with a first portion of said tube and a second portion of said tube, said first portion of said tube engaging said outer bounding surface of said channel having said tube extending away from said second end of said handle, said second portion of said tube being configured to be selectively inserted between the hose and the stem;
a plunger unit being movably coupled to said handle wherein said plunger unit is configured to be manipulated, said plunger unit being in fluid communication with said reservoir wherein said plunger unit is configured to selectively urge the fluid lubricant outwardly through said tube said plunger unit comprising:
a cap having a first wall and a perimeter wall extending away from said first wall, said perimeter wall being continuous such that said perimeter wall forms a closed loop, said perimeter wall having an outside surface, said outside surface of said perimeter wall threadably engaging said threaded portion on said outer wall of said reservoir to releasbly retain said cap on said handle,
a knob being rotatably coupled to said first wall of said cap wherein said knob is configured to be manipulated, said knob being selectively rotated in a first direction, said knob being selectively rotated in a second direction,
a screw being coupled to and extending away from said knob, said screw extending through said first wall of said cap such that said screw extends into said reservoir, and
a disk having a peripheral edge, said screw extending through said disk such that said disk threadably engages said screw, said peripheral edge of said disk engaging said inside surface of said reservoir, said peripheral edge forming a fluid impermeable seal with said inside surface of said reservoir, said disk being urged toward said second end of said reservoir when said knob is rotated in said first direction wherein said disk is configured to urge the fluid lubricant outwardly from said reservoir, said disk being urged toward said first end of said reservoir when said knob is rotated in said second direction; and
a valve being movably positioned within said handle, said valve being in fluid communication with said reservoir, said valve being selectively positioned in a closed position wherein said valve is configured to inhibit the fluid lubricant from exiting said reservoir, said valve being selectively positioned in an open position wherein said valve is configured to facilitate the fluid lubricant to exit said reservoir, said valve comprising:
a ball being slidably positioned in said second sleeve, said ball being positioned between said third ridge and said fourth ridge, said ball engaging said third ridge and forming a fluid impermeable seal with said third ridge when said valve is in said closed position wherein said ball is configured to inhibit the fluid lubricant from passing beyond said ball, said ball being spaced from said third ridge when said valve is in said open position wherein said ball is configured to allow the fluid lubricant to pass beyond said ball, and
a biasing member being positioned in said second sleeve, said biasing member being positioned between said fourth ridge and said ball, said biasing member biasing said ball to engage said third ridge, said ball compressing said biasing member toward said fourth ridge when said knob is rotated in said first direction.
